(19) United States
(12) Patent Application Publication
(10) Pub. No.: US 2008/0126159 A1
(43) Pub. Date: May 29, 2008

(54) METHOD OF MANAGING ADVERTISEMENT AND SYSTEM FOR EXECUTING THE METHOD

(75) Inventors: Wu Sic Wee, Gyeonggi-do (KR); Jung Soo Ha, Gyeonggi-do (KR); Eun Joo Park, Seoul (KR); Min Uk Kim, Seoul (KR); Sung Wook Moon, Gyeonggi-do (KR); Jung Hyun Hwang, Seoul (KR); Min Ho Kim, Seoul (KR)

Correspondence Address: HUSCH BLACKWELL SANDERS LLP, 720 OLIVE STREET, SUITE 2400, ST. LOUIS, MO, 63101, US

(73) Assignee: NHN CORPORATION, Seongnam-si (KR)

(21) Appl. No.: 11/946,037

(22) Filed: Nov. 27, 2007

(30) Foreign Application Priority Data
Nov. 28, 2006 (KR) 10-2006-0118218

(51) Int. Cl. G06Q 30/00; G06Q 10/00

(52) U.S. Cl. 705/7; 705/14

(57) ABSTRACT

A method of managing an advertisement and a system for executing the method are provided. The method of managing the advertisement includes the steps of: detecting non-relevant traffics to an online advertisement of an advertiser; notifying said advertiser of the non-relevant traffics to said online advertisement; and upon receipt of said advertiser's request, stopping said online advertisement based, at least in part, upon the advertiser's request

### CROSS-REFERENCE TO RELATED APPLICATION

This application claims the benefit of Korean Patent Application No. 10-2006-0118218, filed on Nov. 28, 2006, in the Korean Intellectual Property Office, the disclosure of which is incorporated herein by reference.

### BACKGROUND OF THE INVENTION

1. Field of the Invention

The present invention relates to a method of managing an advertisement and a system for executing the method, and more particularly, to a method and system which can warn, of an non-relevant traffic, an advertiser of an advertisement by previously estimating and analyzing generation of the non-relevant traffic of the advertisement.

2. Description of Related Art

Keyword advertisement is a form of advertisement displayed in a search result page when a user performs a search using a search string containing a keyword which an advertiser has purchased. For example, when a user searches for a keyword related to “removal,” an advertisement related to the term “removal” such as “packing removal,” “removal center,” and the like is shown on the results page. The keyword advertisement is different from a banner advertisement that targets random individuals since the keyword advertisement is shown to only people searching for a specific product of interest. Since the keyword advertisement tends to show advertisement contents to only the people having interest in the specific product or a specific item, the keyword advertisement tends to be more effective means of advertisement, e.g., increase the click rate of the advertisement.

The keyword advertisement has a Cost Per Click (CPC) advertisement and a Cost Per Mill (CPM) advertisement.

The CPC advertisement denotes a method of charging advertising costs only when clicking regardless of a number of exposures after a search. Specifically, the CPC advertisement denotes a method of deducting costs for each click only when the advertisement is exposed to a result of a related keyword and a site, in which a link is established, is accessed using a click after the advertiser previously deposits a predetermined desired amount of money.

The CPC advertisement has an advantage of being able to control a rank so that the rank may correspond to a desired rank by processing the advertisement in only a time block which requires the advertisement. Specifically, the advertising costs may be strategically established at only the amount of money nearest to an approximate value of the advertising costs expected by the advertiser. Also, when the advertisement is unnecessary, a full refund is possible when simply waiting for a refund period after a procedure for the refund.

The CPM advertisement denotes a method of processing the advertisement processed during a predetermined period up to only the fixed amount of money regardless of any clicks after designating the fixed amount of money for the advertisement as a flat sum system, or calculating costs according to the number of exposures. For example, when a CPM is 100 won, the advertising costs required for the number of exposures 1,000 are 100 won, and advertising costs of an advertisement displayed on at least one of a top and a bottom of a first image in a general web page are standardized. Here, ‘Mill’ denotes 1,000 in Roman numerals.

However, the advertisement sold in any one of a CPM type and a CPC type has a risk of non-relevant traffic which is not from traffic genuinely interested in the keyword, advertisements and/or product or service associated with the keyword. Non-relevant traffic or abuse of an advertisement in this application is usually referred to as fraudulent exposures or fraudulent clicks. Specifically, the CPM advertisement and the CPC advertisement have a serious vulnerability in which it is possible to adversely affect a pricing system of the advertisement through manipulation of the advertising costs by intentionally performing repetitive clicks on the advertisement or increasing the number of exposures of the advertisement.

### BRIEF SUMMARY

The present invention provides a new technology with respect to a method of managing an advertisement and a system for executing the method.

The present invention also provides a method and system of managing an advertisement which can prevent further non-relevant traffic by stopping an exposure of the advertisement when it is determined that further non-relevant traffic including at least one of a fraudulent exposure and a fraudulent click of the advertisement is generated.

The present invention also provides a method and system of managing an advertisement which can prevent further non-relevant traffic by measuring and maintaining at least one of an exposure pattern and a click pattern of the advertisement, and can determine further non-relevant traffic occurs when a difference from at least one of the exposure pattern and the click pattern of the advertisement during a predetermined time is greater than or equal to a predetermined difference.

The present invention also provides a method and system of managing an advertisement which can prevent further non-relevant traffic by notifying, of the non-relevant traffic, an advertiser of the advertisement in which the non-relevant traffic is generated, and checking, from the advertiser, whether to determine on/off of an exposure of the advertisement.

According to an aspect of the present invention, there is provided a method of managing an advertisement, the method including the steps of: detecting non-relevant traffics to an online advertisement of an advertiser; notifying the advertiser of the non-relevant traffics to the online advertisement; and stopping the online advertisement based, at least in part, upon the advertiser's request. Further, an interface which allows the advertiser to stop the online advertisement for a time period selected by the advertiser can be provided for the advertiser.

In an aspect of the present invention, the non-relevant traffics are either fraudulent exposures of or fraudulent clicks on the advertisement, and the step of detecting non-relevant traffics comprises the steps of: evaluating internet traffics to the online advertisement based, at least in part, upon at least one of an exposure pattern and a click pattern of the online advertisement; and determining non-relevant traffics based, at least in part, upon the evaluated internet traffics to the online advertisement.

In an aspect of the present invention, the step of notifying the advertiser of the non-relevant traffics to the online advertisement comprises the steps of: generating a message including time period of the non-relevant traffics; and transmitting the message to the advertiser. The message may include an interface which allows the advertiser to stop the online advertisement for a time period selected by the advertiser.

According to an aspect of the present invention, there is provided a system for managing an online advertisement, the system comprising: a detection component configured to detect non-relevant traffics to an online advertisement of an advertiser; a notification component configured to notify the advertiser of the non-relevant traffics to the online advertisement; and an advertisement processing component configured to stop the online advertisement based, at least in part, upon the advertiser's request.

According to another aspect of the present invention, there is provided a method of managing an advertisement, the method including the steps of: evaluating internet traffics to an online advertisement of an advertiser based upon at least one of an exposure pattern and a click pattern of the advertisement; determining non-relevant traffics to the online advertisement by using the evaluated internet traffics to the online advertisement; and automatically stopping the online advertisement based upon the determined non-relevant traffics.

### BRIEF DESCRIPTION OF THE DRAWINGS

The above and/or other aspects and advantages of the present invention will become apparent and more readily appreciated from the following detailed description of exemplary embodiments, taken in conjunction with the accompanying drawings of which:

FIG. 1 illustrates an overview of a system for managing an advertisement according to an exemplary embodiment of the present invention;

FIG. 2 is a flowchart illustrating a method of managing an advertisement according to a first exemplary embodiment of the present invention;

FIG. 3 illustrates a method of determining generation of a non-relevant traffic by using at least one of an exposure pattern and a click pattern according to an exemplary embodiment of the present invention;

FIG. 4 is a flowchart illustrating a method of processing an abused advertisement according to a first exemplary embodiment of the present invention;

FIG. 5 is a block diagram illustrating an internal configuration of a system for managing an advertisement according to a second exemplary embodiment of the present invention;

FIG. 6 is a flowchart illustrating a method of managing an advertisement according to a third exemplary embodiment of the present invention; and

FIG. 7 is a block diagram illustrating an internal configuration of a system for managing an advertisement according to a fourth exemplary embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a module. One or more components can reside within a process and/or thread of execution, and a module or component can be localized on one computer and/or distributed between two or more computers.

As used herein, the terms “desktop,” “PC,” “local computer,” and the like, refer to computers on which systems (and methods) according to the invention operate. In the illustrated embodiments, these are personal computers, such as portable computers and desktop computers; however, in other embodiments, they may be other types of computing devices (e.g., workstations, mainframes, personal digital assistants or PDAs, music or MP3 players, and the like).

The present invention is provided in order to estimate, analyze, and process a fraudulent manipulation of advertising costs of an advertisement paid for in any one of a Cost Per Mill (CPM) type and a Cost Per Click (CPC) type, as described above.

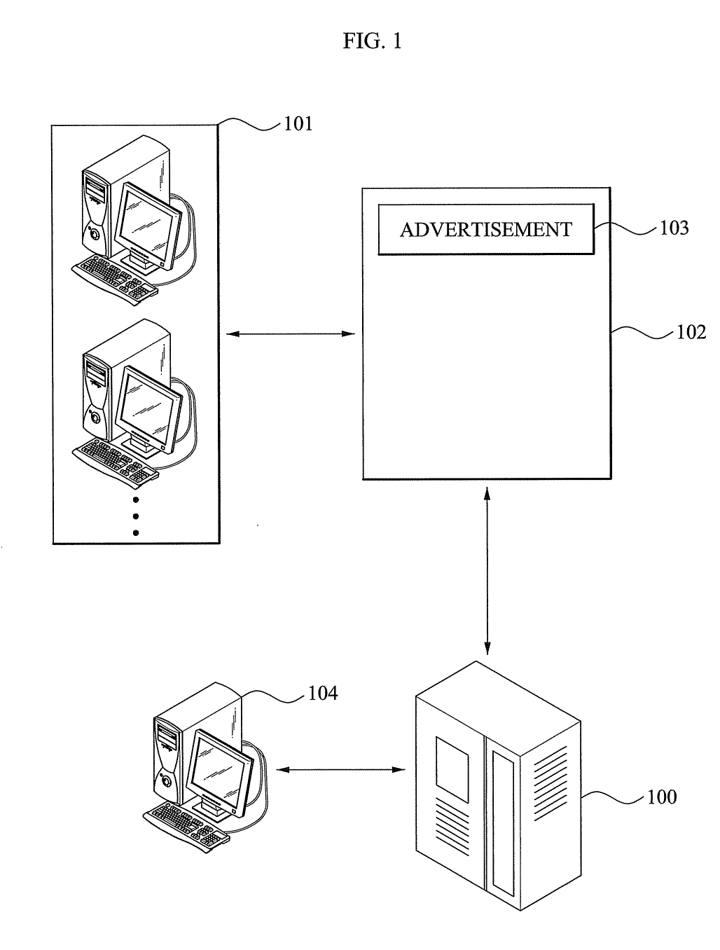

FIG. 1 illustrates an overview of a system 100 for managing an advertisement according to an exemplary embodiment of the present invention.

The system 100 for managing the advertisement may check at least one of an exposure and a click of an advertisement 103 displayed in a web page (or a WAP page) 102 provided for a user terminal 101 via a wired/wireless network, and measure and maintain at least one of an exposure pattern and a click pattern of the advertisement 103. Specifically, an exposure pattern of a CPM advertisement exposed by accessing the web page 102 in the user terminal 101 may be measured and maintained, and a click pattern of a CPC advertisement clicked by using the user terminal 101 may be measured and maintained.

The system 100 for managing the advertisement may stop the exposure of the advertisement and notify, of the stopping of the exposure of the advertisement, an advertiser of the advertisement by previously estimating and analyzing at least one of a fraudulent exposure and a fraudulent click of the advertisement using the measured exposure pattern and the measured click pattern. In this instance, the system 100 for managing the advertisement may transmit, to a terminal 104 of the advertiser, a message of the non-relevant traffic including information related to at least one of the fraudulent exposure and the fraudulent click.

In this instance, a portable device as used in the present specification includes mobile communication devices including a communication function, such as a Personal Digital Cellular (PDC) phone, a personal communication service (PCS) phone, a personal handyphone system (PHS) phone, a code division multiple access (CDMA)-2000 (1×, 3×) phone, a Wideband CDMA phone, a dual band/dual mode phone, a global system for mobile communication (GSM) phone, a mobile broadband system (MBS) phone, a Digital Multimedia Broadcasting (DMB) phone, a smart phone, and a cellular phone; portable terminals such as a personal digital assistant (PDA), a hand-held PC, a notebook computer, a laptop computer, a wireless broadband Internet (WiBro) terminal, an moving pictures experts group layer 3 (MP3) player, and a mini disc (MD) player; and all types of hand-held based wireless communication devices including an International Mobile Telecommunication (IMT)-2000 terminal providing international roaming service and extended mobile communication service. Also, the portable device may include a predetermined communication module such as a CDMA module, a Bluetooth module, an Infrared Data Association (IrDA) module, a wired/wireless local area network (LAN) card and a wireless communication device which is provided with a global positioning system (GPS) chip enabling tracking of a position via a GPS. Also, the portable device may include a microprocessor which can replay multimedia and perform a certain calculation operation.

Also, the message of the non-relevant traffic may include the information of the non-relevant traffic including at least one of the fraudulent exposure and the fraudulent click, and an access function to a site processing the abuse. Also, the message of the non-relevant traffic may be transmitted to the terminal 104 of the advertiser by using a Short Message Service (SMS), a Multimedia Messaging System (MMS), an e-mail, and the like.

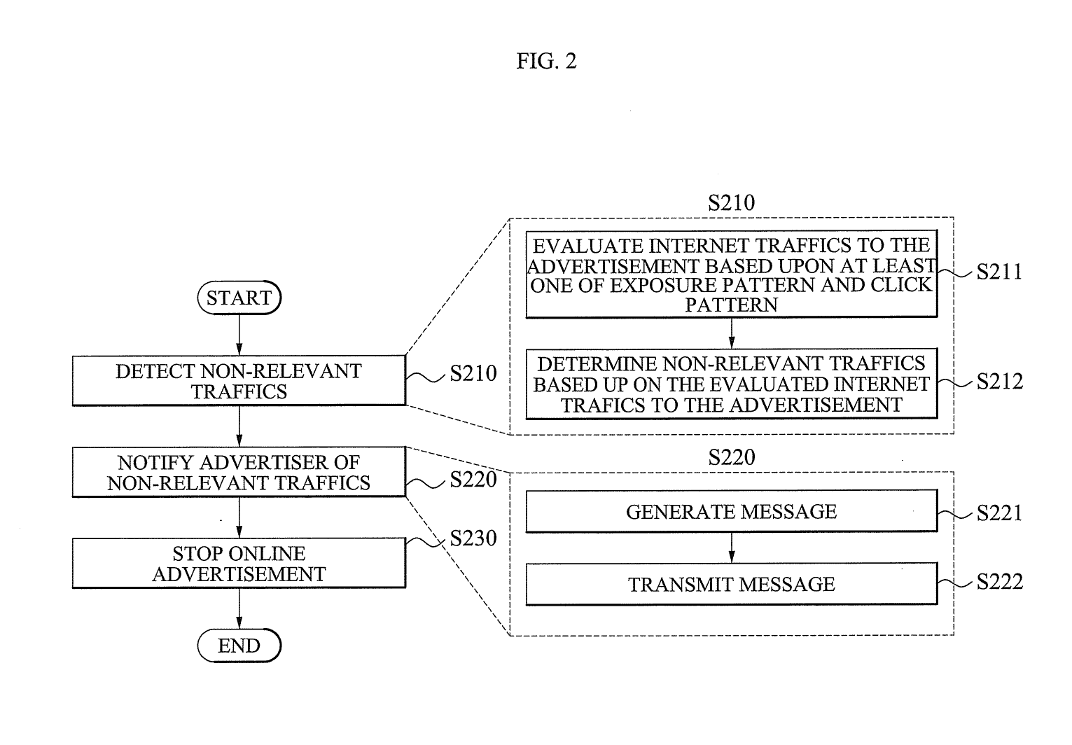

FIG. 2 is a flowchart illustrating a method of managing an advertisement according to a first exemplary embodiment of the present invention.

In operation S210, the system for managing the advertisement determines, as an abused advertisement, an advertisement in which non-relevant traffics are generated. In this instance, the non-relevant traffics include at least one of a fraudulent exposure and a fraudulent click on the advertisement. Specifically, the system for managing the advertisement may determine, as the abused advertisement, the advertisement in which the non-relevant traffic is generated by previously estimating at least one of the fraudulent exposure and the fraudulent click. For this, the determining in operation S210 may include operation S211 and operation S212, as illustrated in FIG. 2.

In operation S211, the system for managing the advertisement measures and maintains at least one of an exposure pattern and a click pattern of the advertisement. In this instance, the exposure pattern and the click pattern may be measured by periodically measuring at least one of a number of exposures of the advertisement and a number of clicks on the advertisement during a predetermined time.

In operation S212, the system for managing the advertisement determines whether the advertisement corresponds to the abused advertisement by using at least one of the exposure pattern and the click pattern when at least one of an exposure of the advertisement and a click of the advertisement is generated. Specifically, whether the advertisement corresponds to the abused advertisement may be determined by summing at least one of the number of exposures of the advertisement and the number of clicks on the advertisement during the predetermined time, and comparing at least one of the number of exposures and the number of clicks for each time block included in at least one of the exposure pattern and the click pattern with at least one of the number of exposures and the number of clicks in a time block related to the predetermined time.

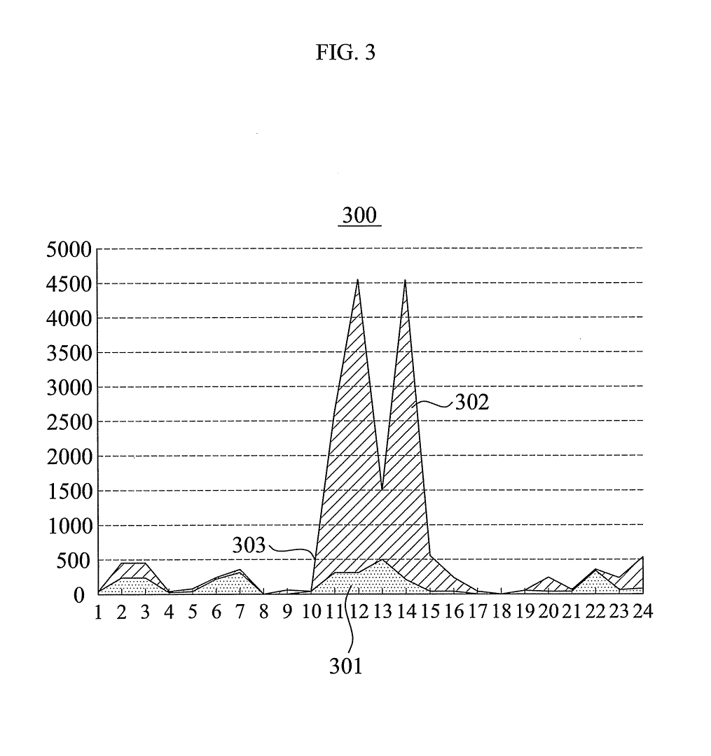

The method of determining generation of the non-relevant traffic of the advertisement is described in detail with reference to FIG. 3.

In operation S220, the system for managing the advertisement notifies, of the non-relevant traffics, an advertiser of the abused advertisement. In this instance, the system for managing the advertisement may notify the advertiser of the non-relevant traffics by generating a message related to the non-relevant traffics and transmitting the message to the advertiser. For this, the notifying in operation S220 may include operation S221 and operation S222, as illustrated in FIG. 2.

In operation S221, the system for managing the advertisement generates a message of the non-relevant traffics including a generation time of the non-relevant traffics of the abused advertisement. The message of the non-relevant traffics includes the generation time of the non-relevant traffics and an access function to a site providing the abuse processing function.

Also, the message of the non-relevant traffics includes contents of the abuse. For example, the message of the non-relevant traffics includes information concerning which of a number of exposures or clicks are excessive by comparing the number of exposures and the number of clicks related to the non-relevant traffics with patterns of the identical time block.

In operation S222, the system for managing the advertisement transmits the message of the non-relevant traffics to a terminal of the advertiser. As described above, the terminal denotes various terminals including a cellular phone, a PC, and the like, and the advertiser selects the terminal for previously receiving the information of the non-relevant traffics.

For example, when the advertiser selects the advertiser's own cellular phone as the terminal and the cellular phone is established in the system for managing the advertisement, the system for managing the advertisement may transmit the message of the non-relevant traffics such as a message provided by an SMS and an MMS using a telephone number related to the cellular phone, or transmit the message of the non-relevant traffics using a prerecorded voice.

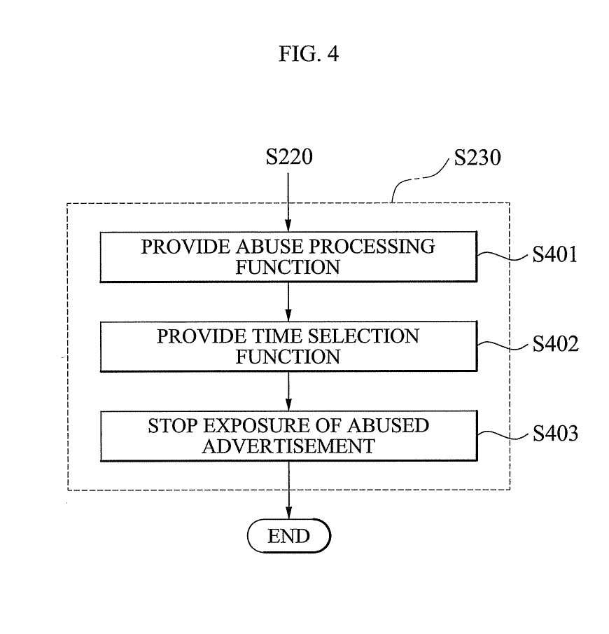

In operation S230, the system for managing the advertisement processes the abused advertisement using an abuse processing function provided for the advertiser. The abuse processing function includes a function of determining on/off of an exposure of the abused advertisement by using a message of the non-relevant traffics transmitted in order to notify the advertiser of the non-relevant traffics. The processing in operation S230 is described in detail with reference to FIG. 4.

FIG. 3 illustrates a method of determining generation of non-relevant traffics by using at least one of an exposure pattern and a click pattern according to an exemplary embodiment of the present invention.

A graph 300 illustrates patterns before and after generation of the non-relevant traffics including a fraudulent click of the advertisement using a number of clicks depending on time. Specifically, a pattern 301 illustrates a click pattern before generation of the non-relevant traffics, and another pattern 302 illustrates a click pattern after generation of the non-relevant traffics.

As illustrated in the graph 300, a great difference between the pattern before generation of the non-relevant traffics and the pattern after generation of the non-relevant traffics is shown based on a feature of the fraudulent click, and the system for managing the advertisement may determine generation of the non-relevant traffics of the advertisement using the difference between the patterns.

For example, when the number of clicks exceeding a number of clicks in the ordinary click pattern is measured as being greater than or equal to a predetermined difference at slightly past ten o'clock in the morning 303, as illustrated for an example, the system for managing the advertisement determines this as generation of the non-relevant traffics, generates the message of the non-relevant traffics, and transmits the message to the advertiser of the advertisement.

Specifically, generation of non-relevant traffics of the advertisement may be dealt with by previously estimating and analyzing generation of the non-relevant traffics, and notifying the advertiser.

Also, even though only the click of the advertisement is described with reference to FIG. 3, the exposure pattern for the exposure of the advertisement is measured using an identical method, and generation of the non-relevant traffics is estimated and processed.

FIG. 4 is a flowchart illustrating a method of processing an abused advertisement according to a first exemplary embodiment of the present invention. As illustrated in FIG. 4, operations S401 through S403 are performed in operation S230 illustrated in FIG. 2.

In operation S401, the system for managing the advertisement provides the abuse processing function for the advertiser. Specifically, as described above, the message of the non-relevant traffics includes the generation time of the non-relevant traffics and an access function to a site providing the abuse processing function, and the system for managing the advertisement provides the abuse processing function for the advertiser by using the access function in the message of the non-relevant traffics.

In operation S402, the system for managing the advertisement provides a time selection function for the advertiser by using the abuse processing function. The abuse processing function includes a function of stopping the exposure of the advertisement during the above-described predetermined time and the time selection function of establishing a time for stopping the exposure.

In operation S403, the system for managing the advertisement stops the exposure of the abused advertisement during a time selected by using the time selection function and the generation time of the non-relevant traffics. The advertiser may establish stopping the exposure of the abused advertisement during the predetermined time by using information related to the non-relevant traffics of the abused advertisement included in the message of the non-relevant traffics, and the time selection function.

The system for managing the advertisement stops the exposure of the abused advertisement during the predetermined time, and exposes the abused advertisement again after the predetermined time.

The advertiser may determine whether to expose the abused advertisement using the message of the non-relevant traffics, and access the site providing the abuse processing function or ignore the message of the non-relevant traffics. For example, since the non-relevant traffics may be generated due to an event performed in the site of the advertiser and the like, the message of the non-relevant traffics may be ignored according to a determination of the advertiser in the above-described special case.

According to the method of managing the advertisement, when it is determined that the non-relevant traffics including at least one of the fraudulent exposure and the fraudulent click on the advertisement is generated, further non-relevant traffics may be prevented by stopping the exposure of the advertisement. Also, further non-relevant traffics may be prevented by measuring and maintaining at least one of the exposure pattern and the click pattern of the advertisement, and determining further non-relevant traffics occur when a difference from at least one of the exposure pattern and the click pattern of the advertisement during the predetermined time is greater than or equal to a predetermined difference.

Also, further non-relevant traffics may be prevented by notifying, of the non-relevant traffics, the advertiser of the advertisement in which the non-relevant traffics are generated and verifying, from the advertiser, determination of on/off of the exposure of the advertisement.

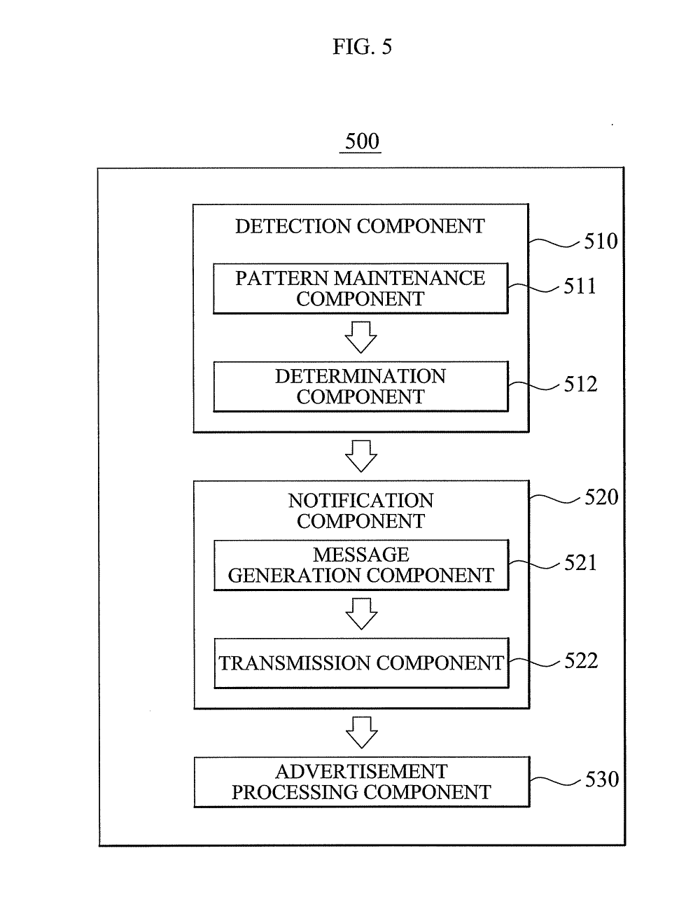

FIG. 5 is a block diagram illustrating an internal configuration of a system 500 for managing an advertisement according to a second exemplary embodiment of the present invention. As illustrated in FIG. 5, the system 500 for managing the advertisement includes a detection component 510, a notification component 520, and an advertising processing component 530.

The detection component 510 determines, as an abused advertisement, an advertisement in which a non-relevant traffic is generated. In this instance, the non-relevant traffic includes at least one of a fraudulent exposure and a fraudulent click on the advertisement. Also, the detection component 510 includes a pattern maintenance component 511 and a determination component 512 in order to determine at least one of the fraudulent exposure and the fraudulent click of the advertisement, and determine the advertisement as the abused advertisement, as illustrated in FIG. 5.

The pattern maintenance component 511 measures and maintains at least one of an exposure pattern and a click pattern of the advertisement. In this instance, the exposure pattern and the click pattern may be measured by periodically measuring at least one of a number of exposures of the advertisement and a number of clicks on the advertisement during a predetermined time.

The determination component 512 determines whether the advertisement corresponds to the abused advertisement by using at least one of the exposure pattern and the click pattern when at least one of an exposure of the advertisement and a click of the advertisement is generated. Specifically, the determination component 512 determines whether the advertisement corresponds to the abused advertisement by summing at least one of the number of exposures of the advertisement and the number of clicks on the advertisement during the predetermined time, and comparing at least one of the number of exposures and the number of clicks for each time block included in at least one of the exposure pattern and the click pattern with at least one of the number of exposures and the number of clicks in a time block related to the predetermined time.

The notification component 520 notifies, of the non-relevant traffic, an advertiser of the abused advertisement. In this instance, the notification component 520 may notify the advertiser of the non-relevant traffic by generating a message related to the non-relevant traffic and transmitting the message to the advertiser. For this, the notification component 520 configured to notify the advertiser of the non-relevant traffic includes a message generation component 521 configured to generate a message of the non-relevant traffic including a generation time of the non-relevant traffic of the abused advertisement, and a transmission component 522 configured to transmit the message of the non-relevant traffic to a terminal of the advertiser, as illustrated in FIG. 5.

The message of the non-relevant traffic includes the generation time of the non-relevant traffic and an access function to a site providing the abuse processing function. Also, the message of the non-relevant traffic includes contents of the abuse.

As described above, the terminal denotes various terminals including a cellular phone, a PC, and the like, and the advertiser selects the terminal for previously receiving the information of the non-relevant traffic.

The advertising processing component 530 processes the abused advertisement using an abuse processing function provided for the advertiser. In this instance, the abuse processing function includes a function of determining on/off of an exposure of the abused advertisement by using a message of the non-relevant traffic transmitted in order to notify the advertiser of the non-relevant traffic.

The advertising processing component 530 provides the abuse processing function for the advertiser in order to process the abused advertisement, provides a time selection function for the advertiser by using the abuse processing function, and stops the exposure of the abused advertisement during a time selected by using the time selection function and the generation time of the non-relevant traffic.

According to the system for managing the advertisement of the present invention, when it is determined that the non-relevant traffic including at least one of the fraudulent exposure and the fraudulent click on the advertisement is generated, further non-relevant traffic may be prevented by stopping the exposure of the advertisement. Also, further non-relevant traffic may be prevented by measuring and maintaining at least one of the exposure pattern and the click pattern of the advertisement, and determining further non-relevant traffic occurs when a difference from at least one of the exposure pattern and the click pattern of the advertisement during the predetermined time is greater than or equal to a predetermined difference.

Also, further non-relevant traffic may be prevented by notifying, of the non-relevant traffic, the advertiser of the advertisement in which the non-relevant traffic is generated and verifying, from the advertiser, determination of on/off of the exposure of the advertisement.

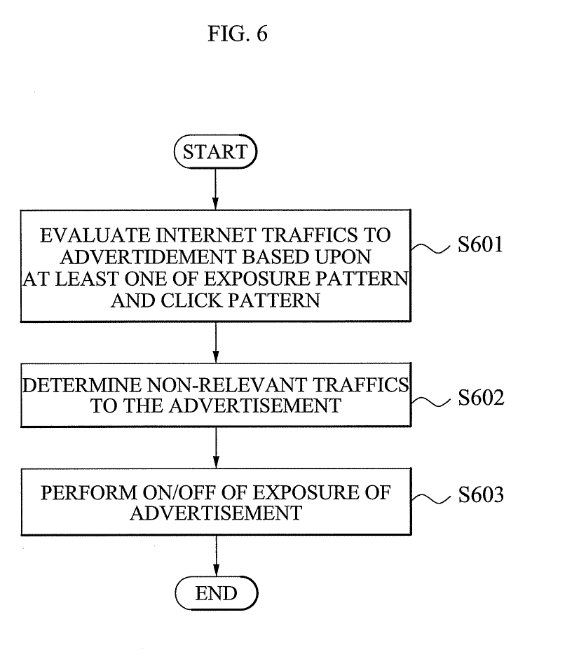

FIG. 6 is a flowchart illustrating a method of managing an advertisement according to a third exemplary embodiment of the present invention.

In operation S601, the system for managing the advertisement measures and maintains at least one of an exposure pattern and a click pattern of the advertisement. In this instance, the exposure pattern and the click pattern may be measured by periodically measuring at least one of a number of exposures of the advertisement and a number of clicks on the advertisement during a predetermined time. Specifically, at least one of the exposure pattern and the click pattern may be measured by measuring at least one of the number of exposures and the number of clicks for each time block, as illustrated in the example of FIG. 3.

In operation S602, the system for managing the advertisement determines whether the advertisement corresponds to an abused advertisement by using at least one of the exposure pattern and the click pattern. In this instance, the system for managing the advertisement may measure at least one of a number of exposures of the advertisement and a number of clicks on the advertisement during a predetermined time, and determine whether the advertisement corresponds to the abused advertisement by using at least one method of comparing the number of exposures with the exposure pattern, and comparing the number of clicks with the click pattern.

Specifically, the system for managing the advertisement may determine whether the advertisement corresponds to the abused advertisement by comparing at least one of the number of exposures of the advertisement and the number of clicks on the advertisement during the predetermined time with at least one of the exposure pattern and the click pattern.

In operation S603, the system for managing the advertisement performs on/off of an exposure of the abused advertisement. In this instance, the system for managing the advertisement stops the exposure of the abused advertisement and notifies, of the stopping of the exposure of the abused advertisement, an advertiser of the abused advertisement, or provides the advertiser of the abused advertisement with information related to generation of the non-relevant traffic by the abused advertisement, and an on/off selection function of the exposure. The non-relevant traffic includes at least one of a fraudulent exposure and a fraudulent click of the advertisement.

When the method of managing the advertisement according to the present invention is used, generation of the non-relevant traffic including at least one of the fraudulent exposure and the fraudulent click of the advertisement may be previously estimated and analyzed. Also, when it is determined that the advertisement corresponds to the abused advertisement, the exposure of the advertisement is stopped, and the advertiser of the advertisement is notified of contents related to generation of the non-relevant traffic.

Alternatively, the non-relevant traffic may be prevented by previously notifying the advertiser of generation of the non-relevant traffic and stopping the exposure of the advertisement according to a selection of the advertiser.

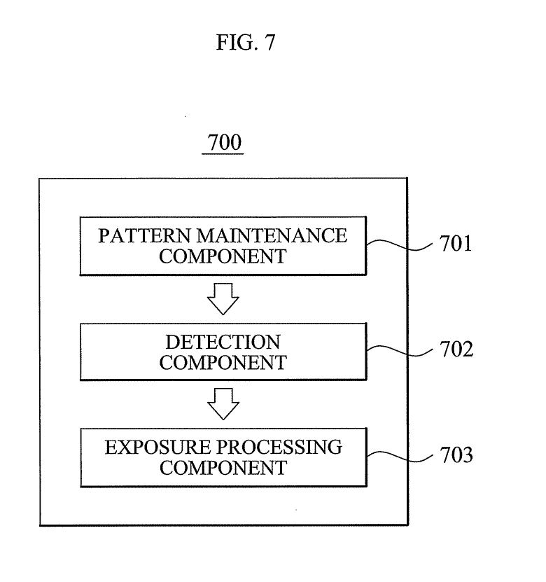

FIG. 7 is a block diagram illustrating an internal configuration of a system 700 for managing an advertisement according to a fourth exemplary embodiment of the present invention. As illustrated in FIG. 7, the system 700 for managing the advertisement includes a pattern maintenance component 701, a detection component 702, and an exposure processing component 703.

The pattern maintenance component 701 measures and maintains at least one of an exposure pattern and a click pattern of the advertisement. In this instance, the exposure pattern and the click pattern may be measured by periodically measuring at least one of a number of exposures of the advertisement and a number of clicks on the advertisement during a predetermined time.

The detection component 702 determines whether the advertisement corresponds to an abused advertisement by using at least one of the exposure pattern and the click pattern. In this instance, the detection component 702 includes an exposure and click measurement component (not illustrated) configured to measure at least one of a number of exposures of the advertisement and a number of clicks on the advertisement during a predetermined time, and a determination component (not illustrated) configured to determine whether the advertisement corresponds to the abused advertisement by using at least one method of comparing the number of exposures with the exposure pattern, and comparing the number of clicks with the click pattern.

Specifically, the exposure and click measurement component may measure at least one of the number of exposures and the number of clicks compared with at least one of the exposure pattern and the click pattern, and the determination component may determine whether the advertisement corresponds to the abused advertisement by comparing at least one of the number of exposures of the advertisement and the number of clicks on the advertisement during the predetermined time with at least one of the exposure pattern and the click pattern.

The exposure processing component 703 performs on/off of an exposure of the abused advertisement. In this instance, the exposure processing component 703 performs any one of: stopping the exposure of the abused advertisement and notifying, of the stopping of the exposure of the abused advertisement, an advertiser of the abused advertisement, and providing the advertiser of the abused advertisement with information related to generation of the non-relevant traffic by the abused advertisement, and an on/off selection function of the exposure, and the non-relevant traffic includes at least one of a fraudulent exposure and a fraudulent click of the advertisement.

According to the system for managing the advertisement of the present invention, generation of the non-relevant traffic including at least one of the fraudulent exposure and the fraudulent click of the advertisement may be previously estimated and analyzed.

Also, when it is determined that the advertisement corresponds to the abused advertisement, the exposure of the advertisement is stopped, and the advertiser of the advertisement is notified of contents related to generation of the non-relevant traffic. Alternatively, the non-relevant traffic may be prevented by previously notifying the advertiser of generation of the non-relevant traffic and stopping the exposure of the advertisement according to a selection of the advertiser.

The exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the present invention, it is possible to prevent further non-relevant traffic by stopping an exposure of the advertisement when it is determined that further non-relevant traffic including at least one of a fraudulent exposure and a fraudulent click of the advertisement is generated.

Also, according to the present invention, it is possible to prevent further non-relevant traffic by measuring and maintaining at least one of an exposure pattern and a click pattern of the advertisement, and determining further non-relevant traffic occurs when a difference from at least one of the exposure pattern and the click pattern of the advertisement during a predetermined time is greater than or equal to a predetermined difference.

Also, according to the present invention, it is possible to prevent further non-relevant traffic by notifying, of further non-relevant traffic, an advertiser of the advertisement in which the non-relevant traffic is generated, and verifying, from the advertiser, determination of on/off of an exposure of the advertisement.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A computer-implemented method of managing an online advertisement, the method comprising the steps of:
detecting non-relevant traffics to an online advertisement of an advertiser;
notifying said advertiser of the non-relevant traffics to said online advertisement; and
upon receipt of said advertiser's request, stopping said online advertisement based, at least in part, upon the advertiser's request.

2. The method of claim 1, wherein the non-relevant traffics are either fraudulent exposures of or fraudulent clicks on the advertisement, and
the step of detecting non-relevant traffics comprises the steps of:
evaluating internet traffics to said online advertisement based, at least in part, upon at least one of an exposure pattern and a click pattern of the online advertisement; and
determining non-relevant traffics based, at least in part, upon the evaluated internet traffics to said online advertisement.

3. The method of claim 1, wherein the step of detecting non-relevant traffics comprises the steps of:
evaluating internet traffics to said online advertisement in accordance with at least one predefined rule; and
determining non-relevant traffics based, at least in part, upon the evaluated internet traffics to said online advertisement.

4. The method of claim 1, wherein the step of notifying said advertiser of the non-relevant traffics to said online advertisement comprises the steps of:
generating a message including time period of the non-relevant traffics; and
transmitting the message to said advertiser.

5. The method of claim 4, wherein the message includes an interface which allows said advertiser to stop said online advertisement for a time period selected by said advertiser.

6. The method of claim 1, wherein the step of stopping said online advertisement comprises the step of providing said advertiser with an interface which allows said advertiser to stop said online advertisement for a time period selected by said advertiser.

7. A computer-implemented method of managing an online advertisement, the method comprising the steps of:
evaluating internet traffics to an online advertisement of an advertiser based upon at least one of an exposure pattern and a click pattern of the advertisement;
determining non-relevant traffics to said online advertisement by using said evaluated internet traffics to said online advertisement; and
automatically stopping said online advertisement based upon said determined non-relevant traffics.

8. The method of claim 7, wherein the step of determining non-relevant traffics to said online advertisement comprises the steps of:
measuring at least one of a number of exposures of the advertisement and a number of clicks on the advertisement during a predetermined time; and
determining non-relevant traffics to said online advertisement by using at least one method of comparing the number of exposures with the exposure pattern, and comparing the number of clicks with the click pattern.

9. The method of claim 7, wherein the step of automatically stopping said online advertisement further comprising the step of notifying said advertiser of the stopping of said advertisement.

10. The method of claim 7, wherein non-relevant traffics are either fraudulent exposures of or fraudulent clicks on the advertisement.

11. A computer-readable record medium storing a program for implementing a method, the method comprising
detecting non-relevant traffics to an online advertisement of an advertiser;
notifying said advertiser of the non-relevant traffics to said online advertisement; and
upon receipt of said advertiser's request, automatically stopping said online advertisement based, at least in part, upon the advertiser's request.

12. A computer-implemented system for managing an online advertisement, the system comprising:
a detection component configured to detect non-relevant traffics to an online advertisement of an advertiser;
a notification component configured to notify said advertiser of the non-relevant traffics to said online advertisement; and
an advertisement processing component configured to stop said online advertisement based, at least in part, upon the advertiser's request.

13. The system of claim 12, wherein the non-relevant traffics are either fraudulent exposures of or fraudulent clicks on the advertisement, and
the detection component comprises:
a pattern maintenance component configured to measure and maintain at least one of an exposure pattern and a click pattern of the advertisement; and
a determination component configured to determine non-relevant traffics to said online advertisement by using at least one method of comparing the number of exposures with the exposure pattern, and comparing the number of clicks with the click pattern.

14. The system of claim 12, wherein the notification component comprises:
a message generation component configured to generate a message including time period of the non-relevant traffics; and
a transmission component configured to transmit said generated message to said advertiser.

15. The system of claim 14, wherein the message includes an interface which allows said advertiser to stop said online advertisement for a time period selected by said advertiser.

16. The system of claim 12, further comprising an interface which allows said advertiser to stop said online advertisement for a time period selected by said advertiser.

17. The system of claim 12, wherein non-relevant traffics are either fraudulent exposures of or fraudulent clicks on the advertisement.

18. A computer-implemented system for managing an online advertisement, the system comprising:
a pattern maintenance component configured to evaluate internet traffics to an online advertisement of an advertiser based upon at least one of an exposure pattern and a click pattern of the advertisement;
a determination component configured to determine non-relevant traffics to said online advertisement by using said evaluated internet traffics to said online advertisement; and
an advertisement processing component configured to automatically stop said online advertisement based upon said determined non-relevant traffics.

19. The system of claim 18, wherein the determination component comprises:
an exposure and click measurement component configured to measure at least one of a number of exposures of said online advertisement and a number of clicks on said online advertisement during a predetermined time; and
a determination component configured to determine non-relevant traffics to said online advertisement by using at least one method of comparing the number of exposures with the exposure pattern, and comparing the number of clicks with the click pattern.

20. The system of claim 19, wherein the exposure processing component performs either stopping the online advertisement with notification thereof, or providing said advertiser with information related to the determined non-relevant traffics and an interface which allows said advertiser to stop said online advertisement for a time period selected by said advertiser.

21. The system of claim 18, wherein non-relevant traffics are either fraudulent exposures of or fraudulent clicks on the advertisement.
